(19) United States
(12) Patent Application Publication
(10) Pub. No.: US 2005/0212894 A1
(43) Pub. Date: Sep. 29, 2005

(54) Direct thermal printer

(75) Inventors: Hidemi Sasaki, Saitama (JP); Fuyuki Inui, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/086,353

(22) Filed: Mar. 23, 2005

(30) Foreign Application Priority Data
Mar. 25, 2004 (JP) 2004-090170

(51) Int. Cl. B41J 2/32; B41J 2/335

(52) U.S. Cl. 347/197

(57) ABSTRACT

A thermal printer is provided with a head shift mechanism for shifting a thermal head and an optical fixer shift mechanism for shifting an optical fixer. The head shift mechanism shifts the thermal head between a recording position to press a recording paper and to thermally record an image, and a retreat position retreating from a transport path of the recording paper. The optical fixer shift mechanism shifts the optical fixer between a fixing position facing the transport path to emit fixing light to a recorded image, and a retreat position retreating from the transport path. The fixing position is in approximately the same space as the recording position of the thermal head. A system controller controls the head shift mechanism and the optical fixer shift mechanism to selectively shift the thermal head and the optical fixer to the recording position or the fixing position.

### BACKGROUND OF THE INVENTION

1. Field of the Invention

The present invention relates to a thermal printer that thermally records an image on a thermal recording paper and then optically fixes the image by emitting fixing light on the image.

2. Background Arts

A direct thermal printer, such as one disclosed in Japanese Patent Laid-Open Publication Number 06-79893, which uses a continuous thermal recording paper wound into a roll, and thermally records an image on the thermal recording paper and then optically fixes the image by emitting fixing light to the image, is practically used. Such continuous thermal recording paper has advantages over a cut-sheet type recording paper in reducing blank areas and in allowing various print sizes by changing the cutting length of the recording paper.

In such a thermal printer, a thermal head for thermally recording the image and an optical fixer for emitting fixing light are disposed on a transport path of the recording paper. Since image recording and optical fixation are performed while the continuous recording paper is transported in a transporting direction and a rewinding direction, the rear end area of the recording paper equivalent to the length required for image recording and optical fixation cannot be used and is thus wasted.

Such problem of wasting can be solved by connecting a leader tape to the rear end of the thermal recording paper. However, a step that is created by the leader tape between the leader tape and the rear end of the recording paper affects the transportation of the recording paper, and the leader tape thus cannot be applied to a photographic printer that should offer the high quality print.

Another direct thermal printer disclosed in Japanese Patent Laid-Open Publication Number 2001-277558 is known for having two fixing light sources with different emission wavelength ranges and an emission opening facing the transport path. This thermal printer selectively guides one of the fixing lights from the two light sources to the emission opening so as to emit the fixing light on the recording paper. This feature contributes to shorten the transport length necessary for the optical fixation because the two kinds of lights with different emission wavelength ranges are emitted through the same emission opening. Thus, the residual area at the rear end of the thermal recording paper can be reduced.

However, even this direct thermal printer is not able to sufficiently shorten the transport length necessary for optical fixation, and a direct thermal printer having even shorter transport length necessary for optical fixation is desired.

### SUMMARY OF THE INVENTION

An object of the present invention is to provide a direct thermal printer that can shorten a transport length necessary for optical fixation.

In order to achieve the above object and other objects, the direct thermal printer of the present invention includes a head shift mechanism and an optical fixer shift mechanism for shifting a thermal head and the optical fixer respectively. The head shift mechanism shifts the thermal head between a recording position and a first retreat position. The thermal head presses against a thermal recording paper to record an image in the recording position, while it retreats from the recording paper in the first retreat position. The optical fixer shift mechanism shifts the optical fixer between a fixing position and a second retreat position. The optical fixer comes very close to the thermal recording paper to emit fixing light in the fixing position, while it retreats from the thermal recording paper in the second retreat position.

Since a shift trajectory of the optical fixer near the fixing position partially overlaps that of the thermal head near the recording position, the optical fixer and the thermal head may interfere with each other. In order to prevent their interference, a controller controls the head shift mechanism and the optical fixer shift mechanism to place the optical fixer in the second retreat position when the thermal head is in the recording position, and to place the optical fixer in the fixing position when the thermal head is in the first retreat position.

In a preferable embodiment of the present invention, the optical fixer has an emission face having a plurality of light-emitting diodes (LEDs) arranged in a matrix. The thermal recording paper wound about a part of the periphery of a platen roller forms a winding part. The image is recorded on the winding part by the thermal head. The optical fixer has an arc-shaped part having the emission face formed thereon.

The thermal head is placed in the recording position while the thermal recording paper is rewound to the recording paper roll, and the optical fixer is placed in the fixing position while the thermal recording paper is drawn from the recording paper roll. The thermal recording paper reciprocates on the platen roller at least three times: the first reciprocation for recording and optically fixing a first color image, the second reciprocation for recording and optically fixing a second color image, and the third reciprocation for recording a third color image. On the emission face, first type LEDs for emitting fixing light of a first wavelength range and second type LEDs for emitting fixing light of a second wavelength range are alternately disposed. The first type LEDs and the second type LEDs optically fix the first color image and the second color image respectively.

According to the direct thermal printer of the present invention, the transport length necessary for optical fixation can be shortened because the thermal head for thermal recording on the thermal recording paper and the optical fixer for emitting fixing light share a part on the transport path. The unusable area at the rear end of a continuous recording paper can be thereby reduced and the recording paper is fairly used up.

### BRIEF DESCRIPTION OF THE DRAWINGS

One with ordinary skill in the art would easily understand the above-described objects and advantages of the present invention when the following detailed description is read with reference to the drawings attached hereto.

FIG. 1 is a schematic view illustrating a constitution of a color direct thermal printer;

FIG. 2 is an explanatory view illustrating an emission face of an optical fixer;

FIGS. 3A and 3B are side views illustrating constitutions of a head shift mechanism when a thermal head is in a recording position and in a retreat position respectively;

FIGS. 4A and 4B are side views illustrating constitutions of an optical fixer shift mechanism when the optical fixer is in a fixing position and in a retreat position respectively; and

FIGS. 5A and 5B are explanatory views illustrating operations both of the head shift mechanism and the optical fixer shift mechanism.

### PREFERRED EMBODIMENTS OF THE INVENTION

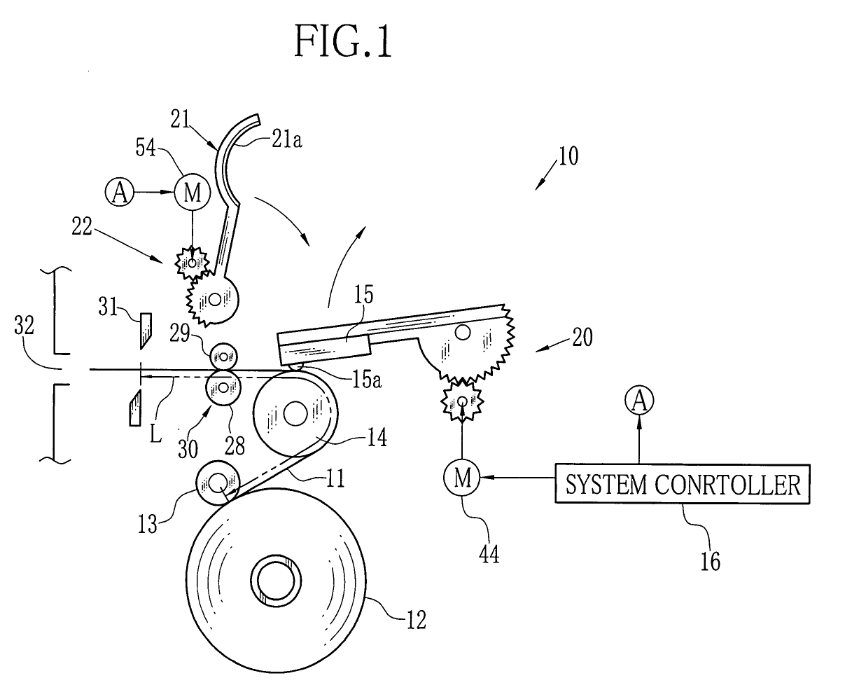

A recording paper roll 12, in which a continuous thermal recording paper (hereinafter referred to as a recording paper) 11 is wound into a roll shape, is loaded in the color direct thermal printer 10 shown in FIG. 1. As is known in the art, a cyan thermosensitive coloring layer, a magenta thermosensitive coloring layer, and a yellow thermosensitive coloring layer are laid on a support in the stated order to form the thermal recording paper 11. The yellow thermosensitive coloring layer, laid on the top of the other two coloring layers, has the highest thermosensitivity among the three coloring layers and develops the yellow color with low thermal energy. The cyan thermosensitive coloring layer, laid under the other two coloring layers, is the lowest thermosensitivity among the three coloring layers and needs high thermal energy to develop the cyan color. The magenta thermosensitive coloring layer develops the magenta color by a thermal energy level between the one to the yellow thermosensitive coloring layer and the other to the cyan thermosensitive coloring layer.

The yellow thermosensitive coloring layer loses its ability to develop the yellow color when exposed to yellow-fixing light, which is ultraviolet rays of blue-violet color having an emission wavelength peak at 420 nm. On the other hand, the magenta thermosensitive coloring layer loses its ability to develop the magenta color when exposed to magenta fixing light, which is near ultraviolet rays having the emission wavelength peak at 365 nm.

A feed roller 13 draws a front end of the recording paper 11 from the recording paper roll 12 to a transport path by contacting and rotating the recording paper roll 12. The transport path is formed of a guide member (not shown) that guides the recording paper 11 under transportation. A platen roller 14 is disposed at the downstream side of the feed roller 13 in order to transport the recording paper 11 along a part of the periphery thereof.

A thermal head 15 is swingably disposed at the downstream side of the platen roller 14 and shifted by a head shift mechanism 20. The thermal head 15 is provided with a heating element array 15a, in which a plurality of heating elements are disposed in a main scanning direction, and supplies heat energy to the recording paper by heating each heating element in accordance with image data while pressing the heating element array 15a against the recording paper 11. The thermal head 15 is connected to a system controller, which is a control device for the whole of the color direct thermal printer 10, and driven by a head driver based on the image data sent from the system controller 16.

The platen roller 14 is disposed facing the heating element array 15a to support the recording paper 11 on the other face of the recording face. The platen roller 14 is rotated by the recording paper 11 under transportation and secures the contact between the recording paper 11 and the heating element array 14a. The recording paper 11 is pressed by the heating element array 15a as nipped by the thermal head 15 and the platen roller 14. The thermal head 15 thermally records the image when the recording area of the recording paper 11 is transported in the rewinding direction after transported past the thermal head 15.

An optical fixer 21 having an emission face 21a on the inner face is disposed near the thermal head 15 to be swingable toward the platen roller 14 by an optical fixer shift mechanism 22. The optical fixer 21 is in the shape of an approximately circular arc with a radius larger than that of the platen roller 14.

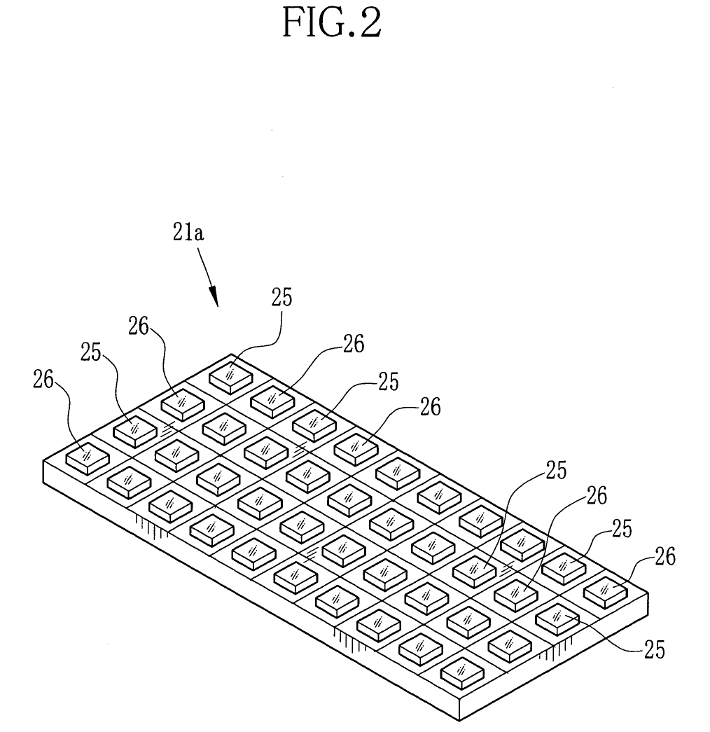

FIG. 2 shows a plain development view of the emission face 21a in the shape of the approximately circular arc. The emission face 21a is provided with a plurality of yellow LEDs 25 for emitting yellow-fixing light and a plurality of magenta LEDs 26 for emitting magenta-fixing light. The yellow LEDs 25 and the magenta LEDs 26 are alternately arranged in a matrix, and emit yellow-fixing light or magenta-fixing light to the recording paper 11 when they are selectively controlled to light up by the system controller 16.

A transport roller pair 30 comprising a capstan roller 28 and a pinch roller 29 are disposed at the downstream side of the thermal head 15 and the optical fixer 21. The transport roller pair 30 nip and reciprocate the recording paper 11 in the transporting direction and the rewinding direction.

The feed roller 13 and the transport roller pair 30 are driven by a transport motor (not shown) to rotate in both forward and reverse directions. The transport motor is controlled by the system controller 16. A cutter 31 is disposed at the downstream side of the transport roller pair 30 to cut the thermally recorded and optically fixed area of the recording paper 11 into a sheet. The cut sheet is discharged out of the printer via a discharge opening 32. The residual recording paper 11 that is not recorded is rewound to the paper roll 12.

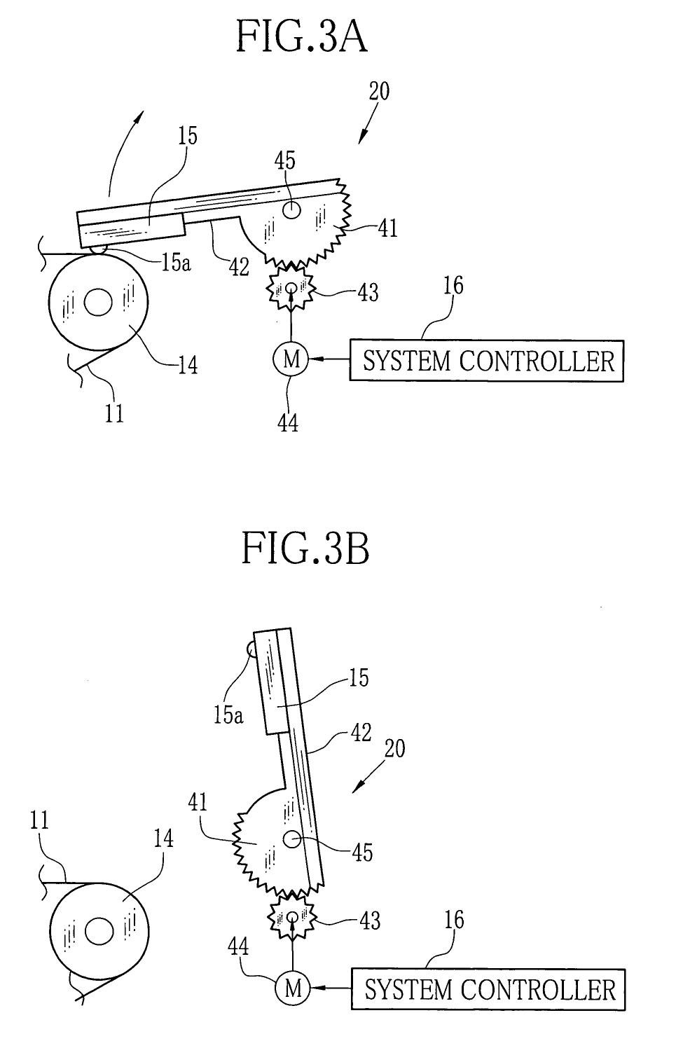

The following is an explanation of the head shift mechanism 20 for shifting the thermal head 15. As shown in FIG. 3A and FIG. 3B, the head shift mechanism 20 is provided with a gear portion 41, a base plate 42 connecting the gear portion 41 and the thermal head 15, a gear 43 for meshing with the gear portion 41, and a motor 44 for rotating the gear 43. The gear portion 41 is rotatably supported by a rotary axis 45, which is disposed approximately parallel to the rotary axis of the platen roller 14.

The motor 44 rotates the gear 43 under the control of the system controller 16. Since the gear 43 meshes with the gear portion 41, the rotation of the gear 43 is transmitted to the gear portion 41. The thermal head 15 is thus swingably shifted by the head shift mechanism 20.

The system controller 16 shifts the thermal head 15 between a recording position and a retreat position by controlling the motor 4. In the recording position shown in FIG. 3A, the thermal head 15 and the platen roller 14 nip the recording paper 11 to press the heating element array 15a against the recording paper 11. The thermal head 15 rotates upward about the rotary axis 45 to retreat from the transport path of the recording paper 11 to the retreat position shown in FIG. 3B.

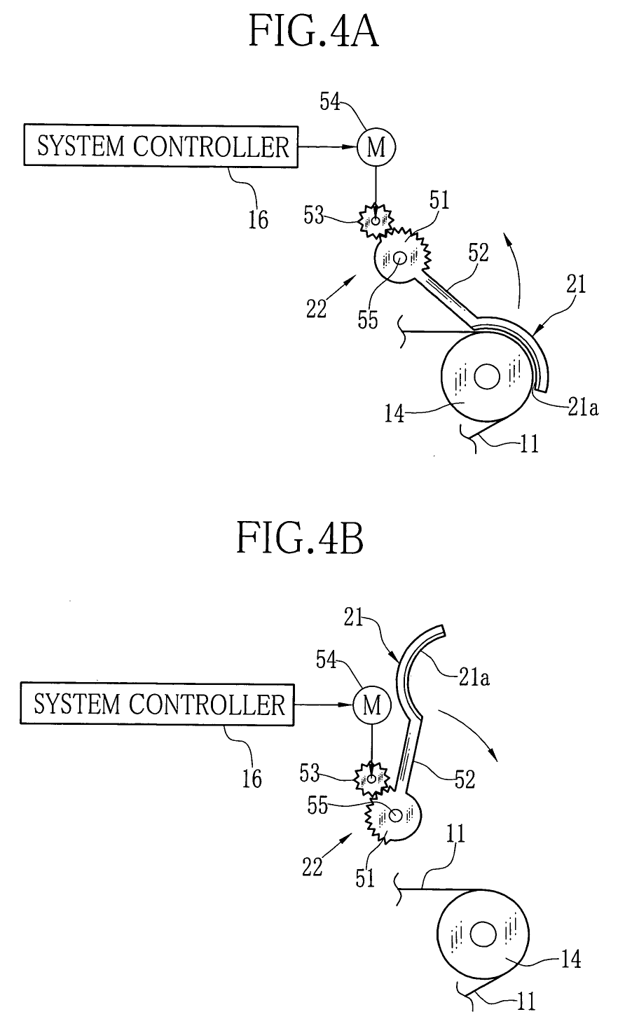

The following is an explanation of the optical fixer shift mechanism 22 for shifting the optical fixer 21. As shown in FIG. 4, the optical fixer shift mechanism 22 is provided with a gear portion 51, a base plate 52 for connecting the gear portion 51 and the optical fixer 21, a gear 53 for meshing with the gear portion 51, and a motor 54 for rotating the gear 53. The gear portion 51 is rotatably supported by a rotary axis 55, which is disposed approximately parallel to the rotary axis of the platen roller 14.

The motor 54 is controlled by the system controller 16. The motor 54 rotates the gear 53. Since the gear 53 meshes with the gear portion 51, the rotation of the gear 53 is transmitted to the gear portion 51. The optical fixer 21 is thus swingably shifted by the optical fixer shift mechanism 22.

By controlling the motor 54, the system controller 16 rotates the optical fixer 21 about the rotary axis 55 between a fixing position to emit the fixing light to the recorded image as shown in FIG. 4A, and a retreat position retreating upward from the transport path of the recording paper 11 as shown in FIG. 4B. In the fixing position, the optical fixer 21 is in approximately the same space with the recording position of the thermal head 15 and faces the transport path on the periphery of the platen roller 14.

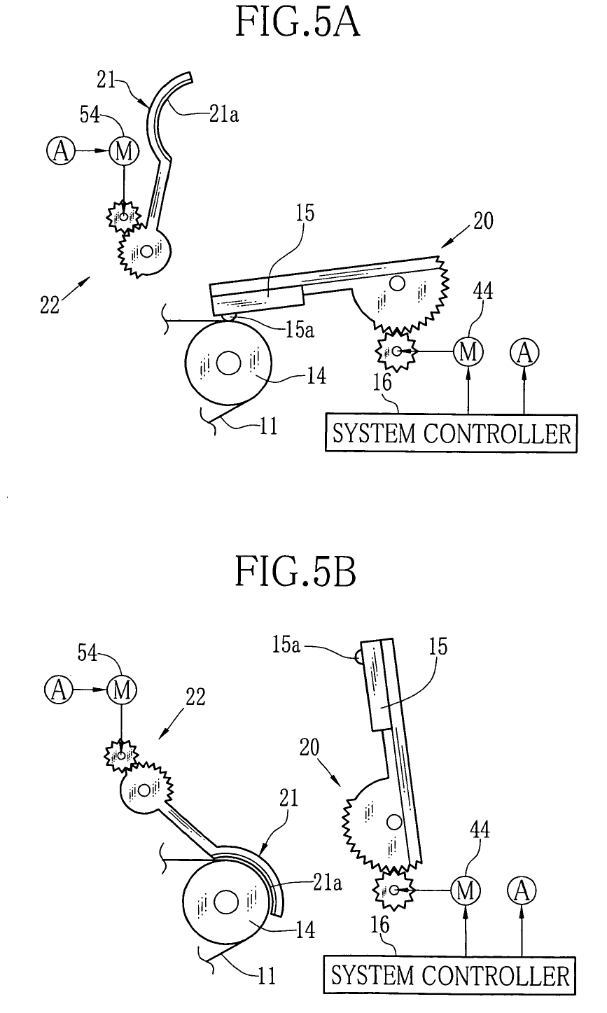

Next is an explanation of the operation of the color direct thermal printer 10 having the above constitution in reference to FIG. 1 and FIG. 5. In response to a print start operation, the system controller 16 rotates the feed roller 13 counterclockwise by controlling the motor (not shown), such that the recording paper 11 is drawn from the paper roll 12. The recording paper 11 drawn from the paper roll 12 is guided by a transport guide (not shown) and transported along the periphery of the platen roller 14.

The recording paper 11 is then nipped by the transport roller pair 30 and transported further downstream. The transportation of the recording paper 11 is stopped when the rear edge of the recording area of the recording paper 11 reaches the recording position. The system controller 16 shifts the thermal head 15 in the retreat position to the recording position by controlling the head shift mechanism 20, such that the recording paper 11 is pressed by the heating element array 15a, as shown in FIG. 5A. Subsequently, the recording paper 11 is transported in the rewinding direction while nipped between the heating element array 15a and the platen roller 14.

At this point, the heating element array 15a is heated in accordance with yellow image data to heat the yellow thermosensitive coloring layer. The yellow image thereby thermally recorded line by line. After thermal recording of the yellow image, the system controller 16 operates the head shift mechanism to shift the thermal head 15 from the recording position to the retreat position. Then, the system controller 16 operates the optical fixer shift mechanism 22 to shift the optical fixer 21 from the retreat position to the fixing position (see FIG. 5B).

When the front edge of the recording area passes the optical fixer 21, the recording paper 11 is transported in the transporting direction and simultaneously the yellow LEDs 25 are turned on and emit yellow fixing light to the recording paper 11. The yellow image is optically fixed while the recording area is passing the optical fixer 21. When the rear edge of the recording area passes the optical fixer 21, the yellow LEDs 25 are turned off and the recording paper 11 is stopped.

Subsequently, the system controller 16 shirts the optical fixer 21 and the thermal head 15 by controlling the optical fixer shift mechanism 22 and the head shift mechanism 20 respectively. The thermal heads presses the thermal head 15a against the recording paper 11 (see FIG. 5A), and the recording paper 11 is then transported in the rewinding direction while nipped between the heating element array 15a and the platen roller 14.

The heating element array 15a is heated in accordance with the magenta image data and thermally records the magenta image line by line in the magenta thermosensitive coloring layer in the recording area while the recording paper 11 is transported in the rewinding direction. After thermal recording of the magenta image, the system controller 16 shifts the thermal head 15 and the optical fixer 21 by controlling the head shift mechanism 20 and the optical fixer shift mechanism 22 (see FIG. 5B).

When the front edge of the recording area passes the optical fixer 21, the magenta LEDs 26 are turned on and emit magenta-fixing light, and simultaneously the recording paper 11 is transported in the transporting direction. The heating element array 15a is heated in accordance with the cyan image data and thermally records the cyan image line by line in the cyan thermosensitive coloring layer in the recording area while the recording paper 11 is transported in the rewinding direction.

After thermal recording of the cyan image, the transport roller pair 30 transport the recording paper 11 in the transport direction to discharge the recorded area via the discharge opening 32. The transport of the recording paper 11 is then suspended, and the recorded area is cut by the cutter 31 and discharged. In order to print sequentially, the foregoing process is performed. To finish printing, the recording paper 11 is rewound to the recording paper roll 12.

Although the thermal head and the optical fixer are swung in the above embodiment, it is also possible to swing the thermal head and shift the optical fixer vertically or horizontally. Furthermore, it is also possible to form the transport path flat and straight and to perform thermal recording and optical fixation to a flatten recording paper.

Although a color direct thermal printer for full-color prints is taken as an example of the present invention in the above embodiment, the present invention is also applicable to a direct thermal printer for monochrome prints.

Furthermore, the present invention is also applicable to the direct thermal printer that uses a recording paper of a cut sheet type instead of the continuous thermal recording paper used in the above embodiment. In this case, the printer may be downsized, since it is possible to shorten the transport path necessary for optical fixation.

Although the present invention has been described with respect to the preferred embodiments, the present invention is not to be limited to the above embodiments but, on the contrary, various modifications will be possible to those skilled in the art without departing from the scope of claims appended hereto.

1. A direct thermal printer including a thermal head for thermally recording an image on a thermal recording paper and an optical fixer for fixing a recorded image, said direct thermal printer comprising:
a head shift mechanism for shifting said thermal head between a recording position and a first retreat position, said thermal head pressing against said thermal recording paper for recording said image in said recording position, said thermal head retreating from said thermal recording paper in said first retreat position;
an optical fixer shift mechanism for shifting said optical fixer between a fixing position and a second retreat position, said optical fixer coming close to said thermal recording paper to emit said fixing light to said thermal recording paper in said fixing position, said optical fixer retreating from said thermal recording paper in said second retreat position, a shift trajectory of said optical fixer near said fixing position and a shift trajectory of said thermal head near said recording position partially overlapping with each other; and
a controller for controlling said head shift mechanism and said optical fixer shift mechanism such that said optical fixer being placed in said second retreat position when said thermal head being placed in said recording position, and that said thermal head being placed in said first retreat position when said optical fixer being placed in said fixing position.

2. A direct thermal printer as defined in claim 1, wherein said optical fixer has an emission face on which a plurality of light-emitting diodes are arranged in a matrix.

3. A direct thermal printer as defined in claim 2, further comprising a platen roller for supporting said thermal recording paper pressed by said thermal head, said thermal recording paper winding around a part of the periphery of said platen roller forms a winding part.

4. A direct thermal printer as defined in claim 3, wherein said optical fixer includes a circular arc part for covering said winding part in said fixing position, said emission face is disposed on the inner face of said circular arc part.

5. A direct thermal printer as defined in claim 4, wherein said thermal head and said optical fixer are swingable.

6. A direct thermal printer as defined in claim 4, wherein said thermal head is placed in said recording position when said thermal recording paper is rewound to a recording paper roll, and said optical fixer is moved to said fixing position when said thermal recording paper is drawn from said recording paper roll.

7. A direct thermal printer as defined in claim 6, wherein said thermal recording paper reciprocates on said platen roller at least three times, for recording and fixing the first color image in the first reciprocation, for recording and fixing the second color image in the second reciprocation, and for recording the third color image in the third reciprocation.

8. A direct thermal printer defined in claim 7, wherein said plurality of light-emitting diodes are first type light-emitting diodes for emitting fixing light in the first wavelength range and second type light-emitting diodes for emitting fixing light in the second wavelength range, said first type light-emitting diodes and said second type light-emitting diodes are alternately disposed, said first type light-emitting diodes light up for optically fixing said first color image, said second type light-emitting diodes light up for optically fixing said second color image.
